(19) United States
(12) Patent Application Publication
(10) Pub. No.: US 2013/0051050 A1
(43) Pub. Date: Feb. 28, 2013

(54) VEHICLE LIGHTING DEVICE

(71) Applicant: HSIU-PEN YANG, NEW TAIPEI CITY (TW)

(72) Inventor: HSIU-PEN YANG, NEW TAIPEI CITY (TW)

(73) Assignee: SONAR AUTO PARTS CO., LTD., NEW TAIPEI CITY (TW)

(21) Appl. No.: 13/218,701

(22) Filed: Aug. 26, 2011

(51) Int. Cl. F21V 13/10; F21V 11/00

(52) U.S. Cl. 362/516; 362/509

(57) ABSTRACT

A vehicle lighting device includes an optical diffusing cover and a light-emitting member. The optical diffusing cover has an inner surface, an outer surface, and a diffusion layer. The diffusion layer is formed on the inner surface. The light-emitting member is arranged adjacently to the optical diffusing cover. After the light is emitted from the light-emitting member, the light encounters the diffusion layer, which diffracts or scatters the light within the optical diffusing cover. The light is then projected from the optical diffusing cover outwardly. Thereby, the vehicle lighting device can have more uniform brightness.

### BACKGROUND OF THE INVENTION

1. Field of the Invention

The instant disclosure relates to a vehicle lighting device; more particularly, to a vehicle lighting device capable of generating uniform illumination.

2. Description of Related Art

In the early days, vehicle lights generally include an optical diffusing cover and a light bulb. Light is emitted by the light bulb and projected through the optical diffusing cover for illumination or warning purposes.

Numerous types of vehicle lights have been developed. One major trend for vehicle light is using an array of light bulbs or light-emitting diodes (LEDs) and covered with an optical diffusing cover. When light is emitted by a set of light bulbs through an optical diffusing cover, a special light source can be detected by the bystanders. This visual recognition of the light source attracts the people's attention more easily. Thus, vehicle lights with such lighting characteristic can have better warning capability.

However, the “lighting effect” of conventional light bulbs arranged in a ring or row-shaped array is still unsatisfactory. For example, the area around the light bulb is brighter, while the area in between each light bulb in an array is darker. In other words, the brightness of the vehicle light as a whole is not evenly distributed. The spectators are likely to think the vehicle light has some dark spots.

### SUMMARY OF THE INVENTION

The instant disclosure provides a vehicle lighting device. The vehicle lighting device can provide a more uniform brightness to enhance the warning capability.

The vehicle lighting device of the instant disclosure comprises an optical diffusing cover and a light-emitting member. The optical diffusing cover has an inner surface, an outer surface, and a diffusion layer. The diffusion layer is formed on the inner surface. The light-emitting member is secured within the optical diffusing cover.

The instant disclosure also provides another vehicle lighting device, which comprises an optical diffusing cover, a light-emitting member, and a light-reflecting member. The optical diffusing cover has an inner surface, an outer surface, and a diffusion layer. The diffusion layer is formed on the inner surface. The light-emitting member is arranged in the optical diffusing cover.

The instant disclosure has the following advantage. The emitted light encounters the diffusion layer, which diffracts or scatters the light before being projected from the optical diffusing cover. The projected light from the optical diffusing cover has a more uniform brightness, which draws the attention of the spectators more easily. Thereby, the vehicle lighting device of the instant disclosure can provide a more effective warning capability.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is an assembled view of a vehicle lighting device for a first embodiment of the instant disclosure.

FIG. 2 is a front view of the vehicle lighting device for the first embodiment of the instant disclosure.

FIG. 3 is a sectional view of the vehicle lighting device in FIG. 2 taken along a cutting-plane 3-3.

FIG. 4 is a schematic view of the vehicle lighting device for the first embodiment of the instant disclosure in use.

FIG. 5 is another schematic view of the vehicle lighting device for the first embodiment of the instant disclosure in use.

FIG. 6 is a sectional view of a vehicle lighting device for a second embodiment of the instant disclosure.

FIG. 7 is a sectional view of a vehicle lighting device for a third embodiment of the instant disclosure.

FIG. 8 is a perspective view of a vehicle lighting device for a fourth embodiment of the instant disclosure.

FIG. 9 is an exploded view of the vehicle lighting device for the fourth embodiment of the instant disclosure.

FIG. 10 is a bottom view of the vehicle lighting device for the fourth embodiment of the instant disclosure.

FIG. 11 is a sectional view of the vehicle lighting device in FIG. 10 taken along a cutting-plane 4-4.

FIG. 12 is a schematic view of the vehicle lighting device for the fourth embodiment of the instant disclosure in use.

FIG. 13 is another schematic view of the vehicle lighting device for the fourth embodiment of the instant disclosure in use.

FIG. 14 is an assembled view of a vehicle lighting device for a fifth embodiment of the instant disclosure.

FIG. 15 is a bottom view of the vehicle lighting device for the fifth embodiment of the instant disclosure.

### DETAILED DESCRIPTION OF PREFERRED EMBODIMENTS

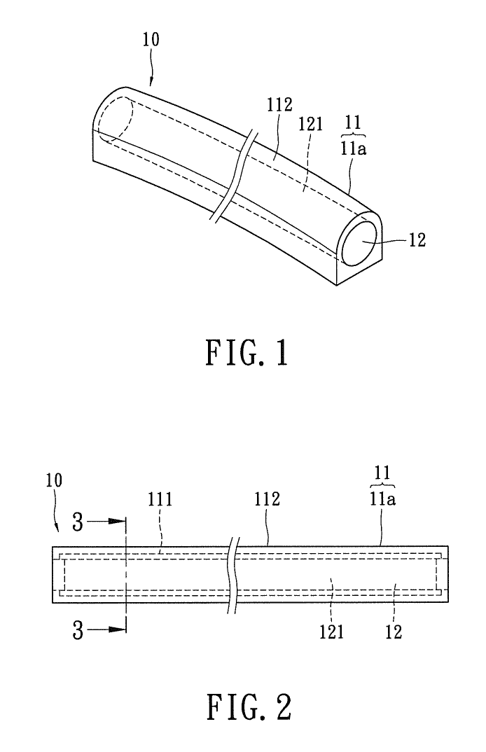

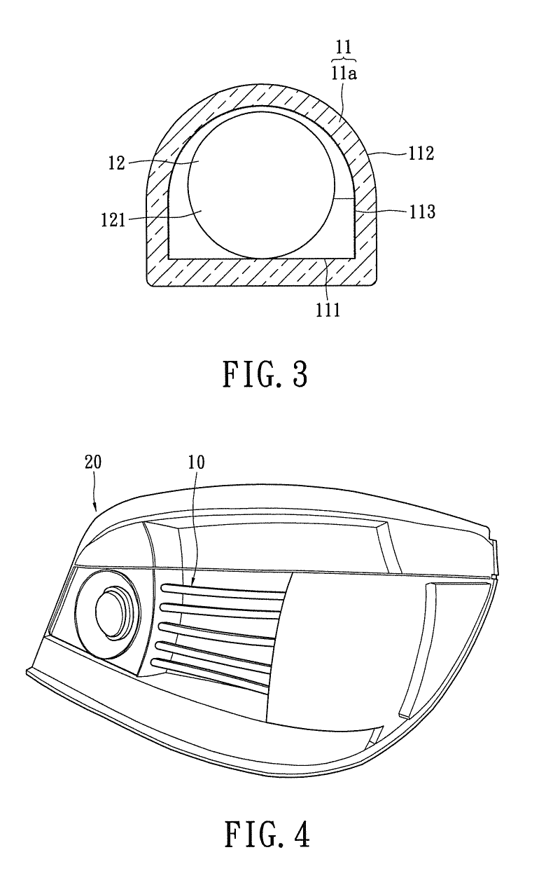

Please refer to FIGS. 1˜3, which show a vehicle lighting device 10 for a first embodiment of the instant disclosure.

The vehicle lighting device 10 comprises an optical diffusing cover 11 and a light-emitting member 12. The technical features and characteristics of the preceding elements will be described in details. Please note, the directional references hereinafter are only for explaining purposes and not used for restricting the scope of the instant disclosure.

The optical diffusing cover 11 can be made of plastic or glass material. In the present embodiment, the optical diffusing cover 11 has a tubular strip body 11a. The strip body 11a can be straight or curved having two opposite ends. For the present embodiment, the strip body 11a takes a curved shape. When taking a front view (FIG. 2), the strip body 11a is seen straight. However, the curved shape of the strip body 11a can be seen with a top view thereof. The strip body 11a can be a one-piece structure formed integrally or an assembled structure of two or more pieces. For the present embodiment, the strip body 11a is a one-piece structure formed integrally.

The optical diffusing cover 11 has an inner surface 111, an outer surface 112, and a diffusion layer 113. The inner surface 111 and the outer surface 112 are formed correspondingly along the strip body 11a. The diffusion layer 113, or a roughened surface, is formed by molding or sand blasting on at least a portion of the inner surface 111. Thereby, localized non-uniformities are formed on at least a portion of the inner surface 111. For the present embodiment, the diffusion layer 113 is formed on a portion of the inner surface 111.

The light-emitting member 12 is arranged within the optical diffusing cover 11. The light-emitting member 12 can be a cold cathode fluorescent lamp 121, which has two terminals wired electrically (not shown).

When the cold cathode fluorescent lamp 121 is turned on, light is emitted. The light encounters the diffusion layer 113, which diffracts or scatters the light in a non-refractive manner in the strip body 11a. The diffracted or scattered light is then projected uniformly from the strip body 11a. By using the vehicle lighting device 10 of the instant disclosure, the spectators can sense visually a light source having a more uniform brightness by looking from the front, rear, top, and bottom thereof. The more uniform brightness allows the vehicle lighting device 10 to be a more effective warning tool.

Please refer to FIG. 4, which shows the vehicle lighting device 10 of the instant disclosure in use. Namely, the vehicle lighting device 10 can be installed to a car illumination assembly 20 at the rear of a car. The opposite ends of the vehicle lighting device 10 are fixed within the car illumination assembly 20, such that the middle portion of the vehicle lighting device 10 can be center-mounted therein.

If the vehicle lighting device 10 flashes or its brightness changes, the purpose can be to display information about the vehicle intention such as braking or turning. The other drivers or pedestrians can be warned through such means. Since the brightness of the vehicle lighting device 10 is more uniformly distributed, the warning capability is more effective.

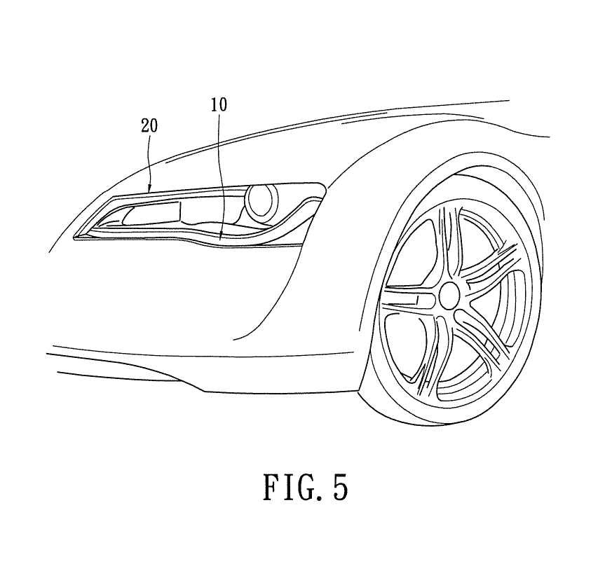

Please refer to FIG. 5, which shows that the vehicle lighting device 10 can also be installed to the car illumination assembly 20 at the front of the vehicle.

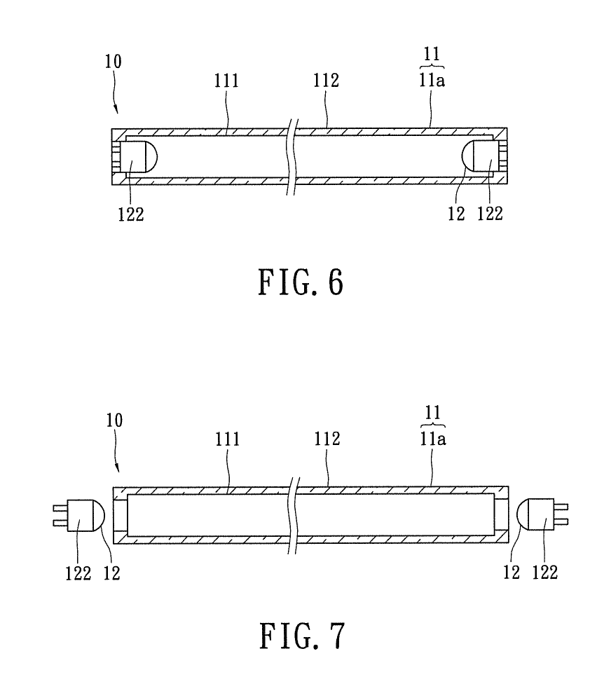

Please refer to FIG. 6, which shows the vehicle lighting device 10 of a second embodiment of the instant disclosure. For this embodiment, the light-emitting member 12 includes two LEDs 122 arranged on the opposite ends of the strip body 11a with their light emitting surface facing toward each other. Specifically, one LED 122 is facing toward the left, while the other LED 122 is facing toward the right.

When the pair of LEDs 122 is turned on, both LEDs 122 would emit light opposite directions and toward each other. The light encounters the diffusion layer 113, which diffracts or scatters the light in a non-refractive manner in the strip body 11a. The diffracted or scattered light is then projected uniformly from the strip body 11a. Thereby, the vehicle lighting device 10 of this embodiment can also provide a light source having more uniform brightness for more effective warning capability.

Please refer to FIG. 7, which shows the vehicle lighting device 10 of a third embodiment of the instant disclosure. Different from the second embodiment, both LEDs 122 of this embodiment are arranged externally of the opposite ends of the strip body 11a. Both LEDs 122 face each other in opposite directions.

Like the second embodiment, when turned on, both LEDs 122 would emit light in opposite direction toward each other. The emitted light is projected into the strip body 11a from opposite ends thereof. The light encounters the diffusion layer 113, which diffracts or scatters the light in a non-refractive manner in the strip body 11a. The diffracted or scattered light is then projected uniformly from the strip body 11a. Thereby, the vehicle lighting device 10 of this embodiment can also provide a light source having more uniform brightness for more effective warning capability.

Please refer to FIG. 4. The vehicle lighting device 10 of the second and third embodiments can also be installed to the car illumination assembly 20. In particular, the two LEDs 122 are blocked by the car illumination assembly 20 therein to not expose the LEDs 122.

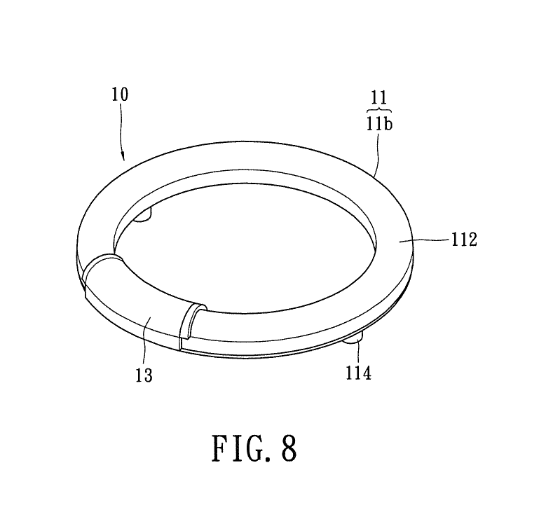

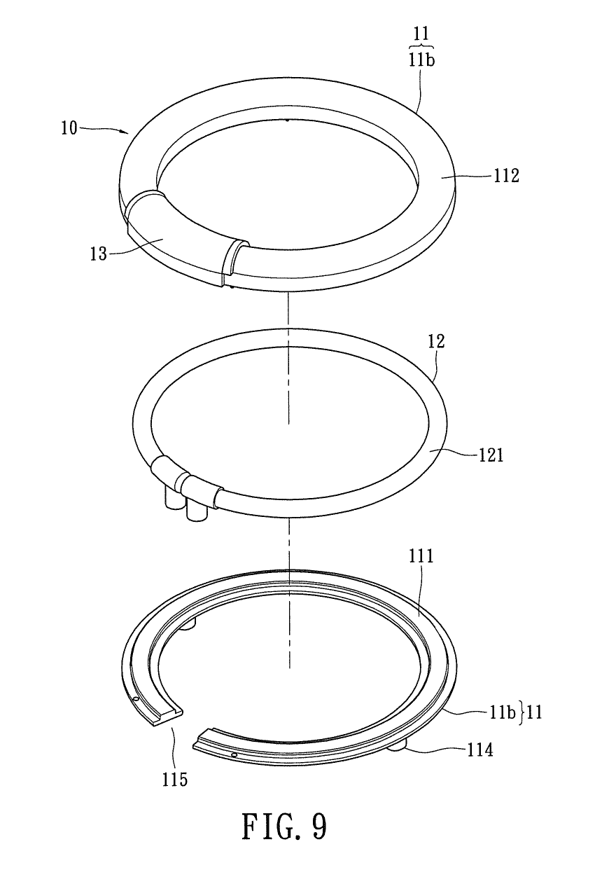

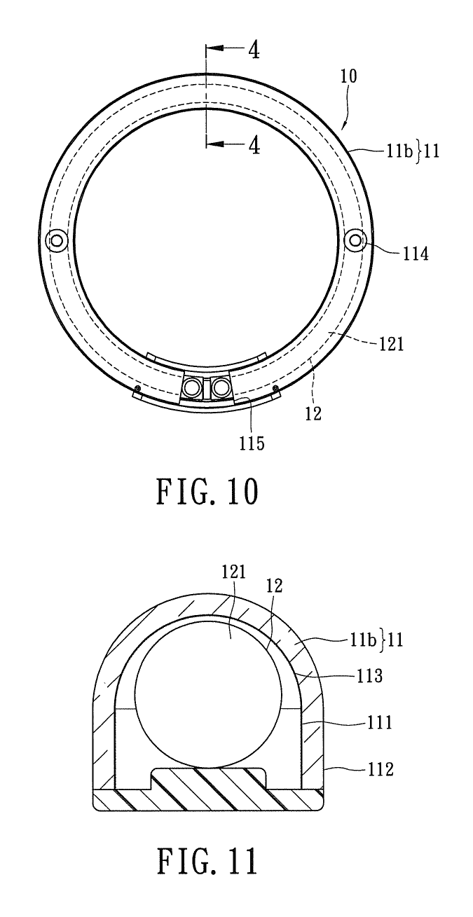

Please refer to FIGS. 8˜11, which show the vehicle lighting device 10 for a fourth embodiment of the instant disclosure.

The vehicle lighting device 10 of this embodiment comprises an optical diffusing cover 11, a light-emitting member 12, and a light-reflecting member 13. Differing from the previous embodiments, the optical diffusing cover 11 of this embodiment has a ring-shaped body 11b, such as shown in the figures. However, the shape of the optical diffusing cover 11 is not restricted, which may be circular, oval, polygonal, etc. The other difference is the addition of the light-reflecting member 13.

The ring-shaped body 11b can be a one-piece structure formed integrally or an assembled structure of two or more pieces. For the present embodiment, the ring-shape body 11b has a circular shape and is a two-piece assembled structure.

The ring-shaped body 11b has the inner surface 111, the outer surface 112, the diffusion layer 113, and two guide posts 114. Notably, the ring-shaped body 11b is not continuous but has a gap 115 formed thereon. The inner surface 111 and the outer surface 112 are formed correspondingly. The diffusion layer 113 is formed by molding or sand blasting on at least a portion of the inner surface 111. Thereby, localized non-uniformities are formed on at least a portion of the inner surface 111. For the present embodiment, the diffusion layer 113 is formed on a portion of the inner surface 111. The guide posts 114 are arranged on the outer surface 112 of the ring-shaped body 11b and are space 180 deg. apart from each other. The gap 115 extends from the outer surface 112 to the inner surface 111 and is spaced 90 degrees away from either guide post 114.

The light-emitting member 12 can be the cold cathode fluorescent lamp 121 arranged within the ring-shaped body 11b. The cold cathode fluorescent lamp 121 is also ring-shaped and has two non-touching terminals wired electrically (not shown).

When the cold cathode fluorescent lamp 121 is turned on, light is emitted. The light encounters the diffusion layer 113, which diffracts or scatters the light in a non-refractive manner in the ring-shaped body 11b. The diffracted or scattered light is then projected uniformly from the ring-shaped body 11b. By using the vehicle lighting device 10 of the instant disclosure, the spectators can sense visually a light source having a more uniform brightness by looking from the front, rear, top, and bottom thereof. The more uniform brightness allows the vehicle lighting device 10 to be a more effective warning means.

The light reflecting member 13 is arranged on the outer surface 112 of the ring-shaped body 11b over the gap 115. The light reflecting member 13 can be mechanically or adhesively secured onto the outer surface 112. The purpose of the light reflecting member 13 is for reflecting the emitted light within the ring-shaped body 11b. Thus, brightness of the vehicle lighting device 10 can be more uniformly distributed.

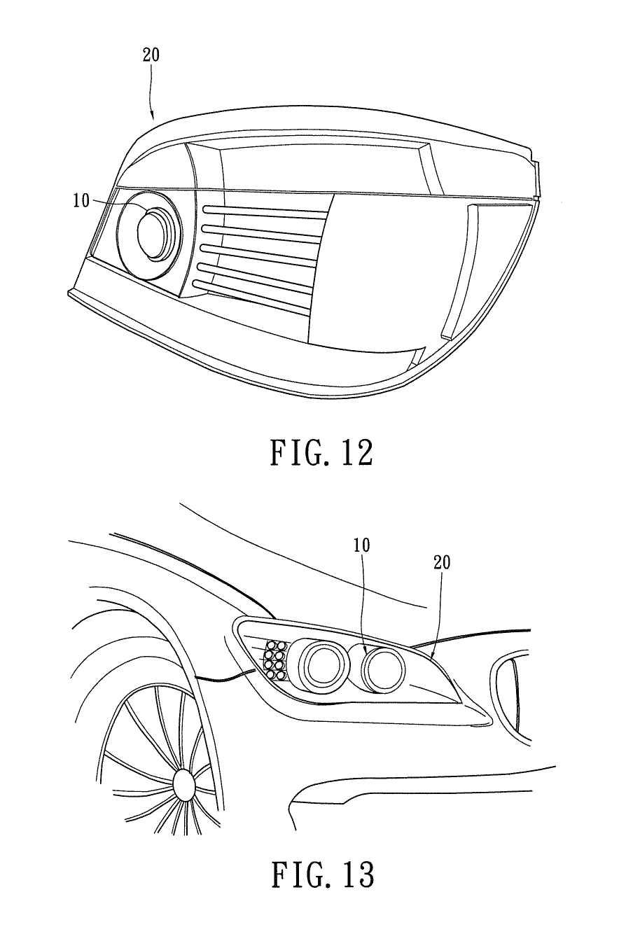

Please refer to FIG. 12, which shows the vehicle lighting device 10 of the instant disclosure in use. The vehicle lighting device 10 can be installed to the car illumination assembly 20 at the rear of a car. The installation can be achieved by the guide posts 114.

Please refer to FIG. 13, which shows the vehicle lighting device 10 can also be installed to the car illumination assembly 20 at the front of the car as well.

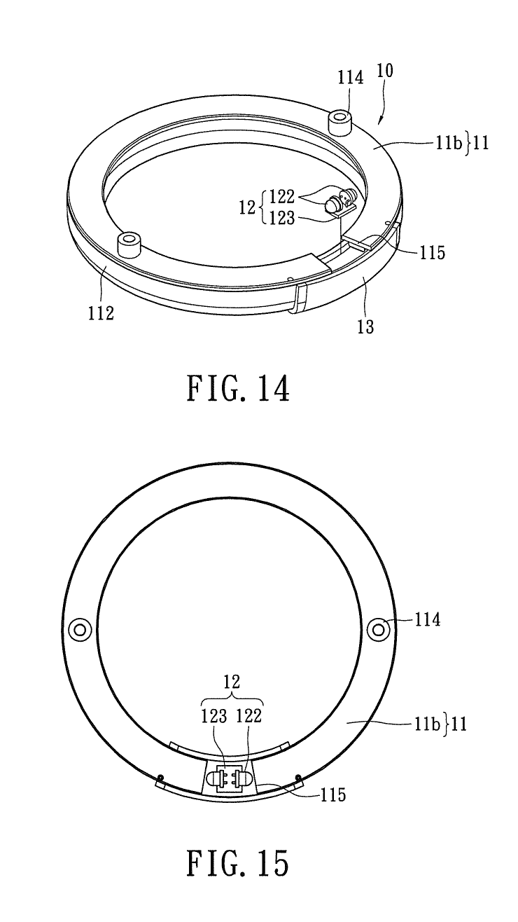

Please refer to FIGS. 14˜15, which show the vehicle lighting device 10 for a fifth embodiment of the instant disclosure. Differing from the fourth embodiment, the light-emitting member 12 of this embodiment includes a pair of LEDs 122 and a circuit board 123. The LEDs 122 are arranged on and electrically connected to the circuit board 123. The LED/circuit board assembly is arranged adjacently to the optical diffusing cover 11, with both LEDs 122 project in opposite directions and away from each other (one toward the left, the other toward the right).

When both LEDs 122 are turned on, light is emitted in opposite directions. The light encounters the diffusion layer 113, which diffracts or scatters the light in a non-refractive manner in the ring-shaped body 11b. The diffracted or scattered light is then projected uniformly from the ring-shaped body 11b. Thereby, the vehicle lighting device 10 of this embodiment can also provide a light source having more uniform brightness for more effective warning capability. The light-reflecting member 13 allows the brightness of the lighting device to be more evenly distributed and blocks the LEDs 122 from being observed directly by the spectators.

Please refer back to FIGS. 12 and 13. Like the fourth embodiment, the vehicle lighting device 10 of the fifth embodiment can also be installed to the car illumination assembly 20 at the front or rear of a car.

Based on the above, the vehicle lighting device 10 of the instant disclosure has the following advantages. First, light is projected in a non-refractive manner to distribute the brightness of the lighting device more evenly in enhancing its warning capability. Second, the light-emitting member 12 can be selected from various choices, such as the cold cathode fluorescent lamp 121 or the LEDs 122.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A vehicle lighting device, comprising:
an optical diffusing cover having an inner surface and an outer surface, wherein a textured optical diffusion layer is formed on the inner surface; and
a light-emitting member secured within the optical diffusing cover.

2. The vehicle lighting device of claim 1, wherein the optical diffusing cover is of strip configuration having a strip tubular body.

3. The vehicle lighting device of claim 1, wherein the optical diffusing cover is of ring configuration having a ring-shaped body.

4. The vehicle lighting device of claim 3, wherein two guide posts are formed on the outer surface of the ring-shaped body.

5. The vehicle lighting device of claim 3, wherein a gap is projected through the ring-shaped body.

6. The vehicle lighting device of claim 3, further comprising a light-reflecting member disposed on the outer surface of the ring-shaped body.

7. The vehicle lighting device of claim 1, wherein the light-emitting member includes a cold cathode fluorescent lamp.

8. The vehicle lighting device of claim 7, wherein the cold cathode fluorescent lamp is disposed within the optical diffusing cover.

9. The vehicle lighting device of claim 1, wherein the light-emitting member includes two light-emitting diodes arranged to project light in opposite direction.

10. The vehicle lighting device of claim 1, wherein the diffusion layer is formed on the inner surface partially.
